(19) United States
(12) Patent Application Publication
(10) Pub. No.: US 2001/0034738 A1
(43) Pub. Date: Oct. 25, 2001

(54) Method and system for managing electronic documents in an agenda process

(75) Inventors: Phillip T. Cantwell, Nashville, TN (US); Ann Mary Masterson, Fairport, NY (US)

Correspondence Address: Gunnar G. Leinberg, Esq., NIXON PEABODY LLP, Clinton Square, P.O. Box 31051, Rochester, NY, 14603-1051, US

(73) Assignee: Xerox Corporation

(21) Appl. No.: 09/791,522

(22) Filed: Feb. 22, 2001

Related U.S. Application Data
(60) Provisional application No. 60/184,138, filed on Feb. 22, 2000.

(51) Int. Cl. G06F 17/21

(52) U.S. Cl. 707/500; 707/530

(57) ABSTRACT

Method, system and computer-readable medium containing instructions for agenda management integrating imaging, document management, workflow processes, intelligent forms and output management. Imaging is used to capture hard-copy documents into an electronic document management system where they are stored and indexed in one or more databases for subsequent searching and retrieval. Documents inputted electronically at a workstation or other computing device are electronically delivered to an agenda management system where they are to be stored. Workflow processes are utilized to automatically route the electronic documents to all parties involved in the approval process and to track their status. Intelligent forms are used to populate a database and the information is used to populate auto filled templates. Output management is used to publish the auto-filled templates, which include meeting agendas and associated minutes for use by an organization and members of the public.

This application claims the benefit of U.S. Provisional Patent Application Serial No. 60/184,138 filed on Feb. 22, 2000, which is herein incorporated by reference.

### FIELD OF THE INVENTION

This invention relates generally to managing an agenda electronically and, more particularly, to a method and system for managing electronic documents in an agenda process.

### BACKGROUND OF THE INVENTION

Governing bodies are required by law to generate and publish agendas containing information concerning the items they will consider. Generating and publishing agendas, including associated meeting minutes, is oftentimes important to the work of governing bodies as well as others.

Conventional agenda processes are typically paper-based. Governing bodies and other organizations have found it difficult to route and track the often overwhelming number of hard-copy documents. Since these documents must be shared amongst many people prior to their inclusion in an agenda, managing the documents becomes an important task. Manually managing such a large number of hard-copy documents can be difficult and often results in delays and/or lost or mis-routed information. Moreover, accessing the information contained in the documents created and used during the agenda process typically requires labor intensive searches since the documents may be archived on off-line media such as microfiche or hard-copy files.

### SUMMARY OF THE INVENTION

A method for managing an agenda in accordance with the present invention includes determining if one or more agenda items are approved for inclusion in a meeting agenda electronically, adding the approved agenda items to the meeting agenda to generate an updated agenda electronically and publishing the updated agenda.

A program storage device readable by a machine tangibly embodying a program of instructions executable by the machine to perform a method for managing an agenda in accordance with the present invention includes determining if one or more agenda items are approved for inclusion in a meeting agenda electronically, adding the approved agenda items to the meeting agenda to generate an updated agenda electronically and publishing the updated agenda.

A system for managing an agenda in accordance with the present invention includes a determination processing system that determines if one or more agenda items are approved for inclusion in a meeting agenda electronically, an agenda processing system that adds the approved agenda items to the meeting agenda to generate an updated agenda electronically and a publishing system that publishes the updated agenda.

### BRIEF DESCRIPTION OF THE DRAWINGS

FIGS. 1 is a block diagram of a system for managing an agenda in which document processing and management are centralized in accordance with one embodiment;

FIG. 2 is a flow chart of a process for managing an agenda in accordance with another embodiment;

FIG. 3 is a block diagram of a system for managing an agenda in which document processing and management are decentralized in accordance with another embodiment; and

FIG. 4 is a block diagram of a system for managing an agenda in which document processing is decentralized and document management is centralized in accordance with yet another embodiment.

### DETAILED DESCRIPTION OF THE INVENTION

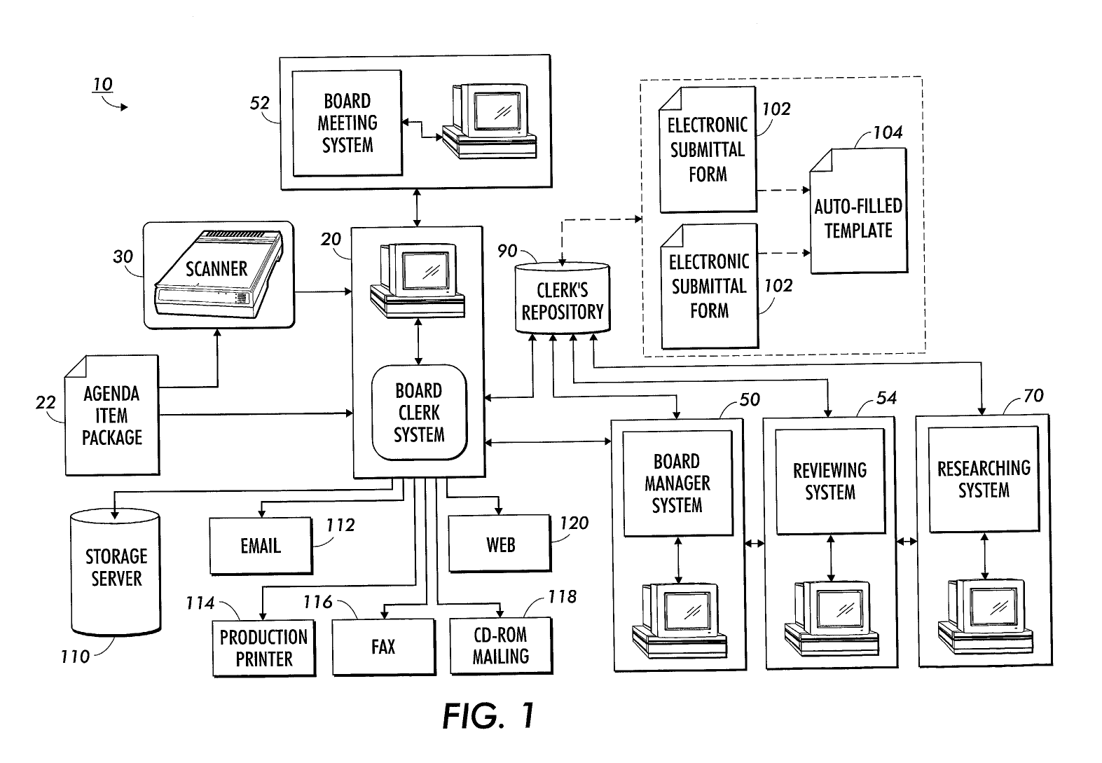

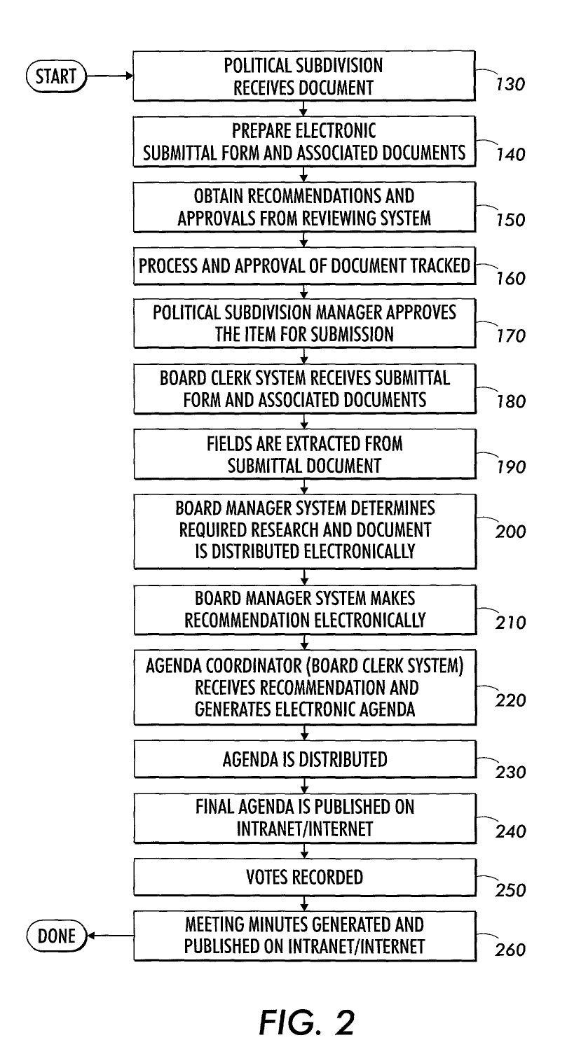

A system 10 and a method for managing an agenda in accordance with one embodiment of the present invention are illustrated in FIGS. 1 and 2. The system 10 includes a board clerk system 20 and determines if one or more agenda items are approved for inclusion in a meeting agenda electronically and then adds the approved agenda items to the meeting agenda to generate an updated agenda electronically. One of several features of the present invention is enabling individuals to participate in an agenda process using a Web page browser, without needing any special equipment or software. Another feature is that the process for adding proposed items to an agenda is streamlined, automated and simplified. Yet another feature is that agendas and associated meeting minutes and documents are easily accessible.

While a political subdivision is used for exemplary purposes only herein, any organization can utilize the agenda management system of the present invention. Typically, these organizations will have a governing body (“governing body”), often elected but not always, such as a city council, board, or other collection of individuals which are involved in the agenda process.

Referring more specifically to FIG. 1, in this particular embodiment system 10 includes a board clerk system 20, a board manager system 50, board meeting system 52, a reviewing system(s) 54 and a researching system(s) 70 (“agenda participant systems ”) which are each operated by one or more individuals, although system 10 can comprise other components and/or systems and other combinations of components and/or systems. Board clerk system 20 is responsible for coordinating the agenda management process described herein further below. System 10 allows individuals outside of system 10 to interact with the board clerk system 20 to review, approve or disapprove, and add comments to proposed items for adding to a meeting agenda of, or creating a new meeting agenda for a governing body. In this particular embodiment, board clerk system 20 executes a program of stored instructions for managing an agenda in accordance with one embodiment of the present invention as described herein and set forth in FIG. 2, although some or all of these programmed instructions could be stored and/or executed by other agenda participant systems. Additionally and alternatively, some or all of the programmed instructions can be stored on computer-readable medium for execution by a processor(s) in one or more of the agenda participant systems. Examples of such computer-readable mediums include floppy disks, hard disks, Zip® disks, CD-ROM's, DVD-ROM's, computer-readable cassette tapes or reels, or computer-readable punched cards. While the agenda participant systems are shown separately from each other, it should be understood that in other embodiments a single computer system could be used to performing all of the agenda management processes described herein.

Each of the agenda participant systems discussed above may comprise a variety of different types of computer processing systems or machines, including personal desktop computers, laptop computers, work stations, palm top computers, Internet-ready cellular/digital mobile telephones, dumb terminals or any other larger or smaller computer systems or servers. Moreover, the abovementioned machines can utilize many different types of platforms and operating systems, including, for example, Linux®, Windows®, Windows CE®, MacIntosh®, Unix®, SunOS®, and variations of each. Each of the agenda participant systems may have the capability of sending or receiving electronic documents to other computers or networks (e.g., Intranet or Internet). Each of the agenda participant systems are operated by one or more individuals involved with the agenda being managed.

In this particular embodiment, each of the agenda participant systems include one or more processors (not illustrated), one or more memory storage devices (not illustrated) and one or more interfaces, including communication devices such as modems (not illustrated) coupled together by one or more buses. Moreover, in this particular embodiment each of the agenda participant systems can load and display e-mail interfaces retrieved from a repository or other memory database or storage device. A number of e-mail applications can be utilized in the present invention, such as Outlook®, Eudora® or AOL®, to generate, send, receive or display e-mail messages with included or attached electronic documents.

In this example, each of the agenda participant systems includes a display device for displaying e-mail interfaces, Web pages through a Web browser program, such as Internet Explorer® or Netscape®, or other types of software interfaces, although a display device may not be necessary for every agenda participant system. A variety of different types of display devices can be used, such as a color computer monitor, a monochrome, gray scale monitor, a printer, or a number of other different types of display devices.

The board clerk system 20 may also be coupled to a network of users (not illustrated) independent of the governing body agenda participant systems. The network can include hundreds of thousands of individual networks of computers such as the Internet. The agenda participant systems can communicate with the network in a variety of ways, including using conventional TCP/IP, xDSL, ISDN or cable connections. A variety of communication systems and/or processes can be used to operatively couple the agenda participant systems to each other for communication, such as a LAN or WAN, a dial-up connection through a PBX or wireless communication technology.

Board clerk system 20 maybe coupled to scanner 30 and is used for converting hard-copy agenda item packages 22 into electronic format. Board clerk system 20 may also be coupled to clerk's repository 90, where information associated with agenda item packages 22 is stored. In this particular embodiment, clerk's repository 90 is a separate storage server. However, clerk's repository 90 may be located within board clerk system 20 and stored in a memory storage device, such as RAM, ROM, hard-disk, floppy-disk, CD-ROM, DVD-ROM, or other computer-readable medium. Moreover, board manager system 50, reviewing system 54 and researching system 70 are coupled to clerk's repository 90 for accessing stored submittal forms 102 and auto-filled templates 104 during an agenda review and approval process.

Meeting agendas include information concerning a governing body's agenda of items to be considered and acted upon and their associated agenda item documents. Meeting minutes are a summary of the consideration given by the governing body concerning the items in a meeting agenda along with the actions and votes but without the associated agenda item documents. In particular, the meeting minutes include, but are not limited, to votes, actions, motions and attendance. Information from the meeting agendas and associated meeting minutes are input into auto-filled templates 104 using information extracted from electronic submittal forms 102 and associated documents, as described in more detail herein further below. Auto-filled templates 104 are used to generate .pdf, .html, .xml or .doc files that may include hyperlinks or Universal Resource Locators (“URLs”) pointing to information with respect to an meeting agenda, and are stored in clerk's repository 90. Electronic submittal forms 102 form a portion of agenda item package 22 and include proposed agenda information and other pertinent information. Documents associated with a proposed agenda item, either in hard-copy or in electronic format, form another portion of agenda item package 22. In this particular embodiment, a facility, typically the physical location of a governing body where board clerk system 20 is situated, receives hard-copy documents through a regular delivery method, such as regular mail, courier service, hand-delivery or facsimile. The received hard-copy documents can be converted by an individual into electronic format using scanner or other inputting device or technique. Also in this particular embodiment, board clerk system 20 can receive documents already in electronic format from, for example, an agenda participant system and/or an individual outside of the governing body, via an e-mail message with one or more attachments.

Board clerk system 20 may be coupled to at least one storage server 110 for archiving electronic submittal forms 102, associated documents in electronic format and auto-filled templates 104 containing meeting agenda and associated meeting minutes information. Additionally, board clerk system 20 may be coupled to various output devices for publishing meeting agenda and associated meeting minutes information. In this particular embodiment, publishing includes making the above-mentioned information accessible to members of the public or agenda participant systems by e-mail 112, production printer 114, fax 116, CD-ROM mailing 118 and the Web 120.

Referring more specifically to FIG. 2, the operation of one embodiment of system 10 will be described. Beginning at step 130, a department, agency, elected official of a governing body, or other organization receives one or more documents (“agenda item documents”) containing requests to take at least one action. Agenda item documents are received from internal staff, other governmental agencies at the local, state or federal level or any of the entities mentioned above. Additionally, the agenda item documents comprise a variety of papers, including contracts, studies, reports, resolutions or proposed ordinance changes. If the documents are received in electronic format, such as via an attachment to an e-mail message, board clerk system 20 receives the documents. If the documents are received in hard-copy format, they are converted into electronic format using scanner 30 and then transferred to the board clerk system 20. Additionally, Optical Character Recognition (“OCR”) can be performed on the scanned images to recognize the text within each document. The scanned documents are automatically associated with electronic submittal form 102 by board clerk system 20. For example, the requesters may use prefabricated forms that include bar codes identifying the particular meeting agenda a proposed agenda item is intended for. Further, board clerk system 20 can edit and revise each of the scanned images, if necessary, and can perform quality assurance to validate that the scanned image is an accurate representation of the original hard-copy documents, either manually or automatically.

At step 140, the individual (“requester”) requesting that an agenda item be placed on an meeting agenda completes an electronic version of a submittal form (i.e., electronic submittal form 102), which is then associated with the received agenda item documents by board clerk system 20, forming agenda item package 22. The submittal form includes one or more fields for referencing each of the associated agenda item documents. Alternatively, the requesters can download or access a locally stored electronic submittal form 102 and send in, for example via an e-mail message to an e-mail address, the electronic submittal form 102 along with the associated agenda item documents as agenda item package 22 to board clerk system 20.

At step 150, agenda item package 22 is forwarded, either electronically or by physical delivery, to reviewing system 54 for comments and approval. For example, the documents could be forwarded to a number of individuals such as committees, finance officers, legal counsel or a number of other individuals who would make recommendations, approvals or disapprovals and/or comments after reviewing the documents using one or more reviewing systems 54. Board manager system 50 determines from whom approval for each agenda item package is required and an electronic version and/or hard-copy version of that agenda item package 22 is distributed to those reviewing systems 54.

At step 160, once agenda item package 22 is submitted for approval, an individual, such as a bureau clerk, or a work flow software, can be used to track the progress of the approvals (i.e., that the document was received and opened, recommendation or action was returned, etc.) for each reviewing system 54. The hard-copy documents go through a serial referral and approval process that is manually or automatically tracked using the workflow software. Reviewing system 54 can note their approval or disapproval on electronic submittal form 102. Recommendations of each reviewer at a reviewing system 54 can also be noted in writing. Additionally, a signature, either a written signature on a hard-copy version of electronic submittal form 102 and/or an electronic signature on electronic submittal form 102 indicates approvals. Board clerk system 20 updates or more fields in electronic submittal form 102 to contain hyperlinks or URLs pointing to each of the agenda item documents associated with agenda item package 22, and notes whether the required approvals were obtained. In addition or alternatively, hyperlinks or URLs may be displayed on a Web page produced by board clerk 20 and accessible by the agenda participants. The associated agenda item documents are then indexed and stored in clerk's repository 90 to facilitate subsequent electronic searching and retrieval. Board clerk system 20 then sends an e-mail message to board manager system 50 containing the hyperlink or URL of the electronic submittal form, which in turn now contains hyperlinks or URLs to each of the documents associated with agenda item package 22. Additionally or alternatively, hyperlinks or URLs may be displayed on a Web page as explained above. At any point, individuals with correct permissions can query a database stored at clerk's repository 90 to see who has taken an action, what the action was and which individuals have not yet completed the review and approval process. Additionally, the work flow software can run on any of the servers or computer systems utilized in the present invention. An example of workflow software that can be utilized by the present invention includes FYI by Identitech, Inc., which is herein incorporated by reference.

At step 170, once the electronic submittal form 102 and associated agenda item documents, with recommendations, approvals or disapprovals and/or comments are complete, assuming the minimum number of reviewing systems 54 have approved the agenda items contained in agenda item package 22, a political subdivision manager (i.e., board manager system 50) approves the item for submission to the governing body's meeting agenda. However, it should be appreciated that in other embodiments fewer than all of reviewing systems 54 are needed to approve the items for addition to the meeting agenda. The agenda coordinator (i.e., board clerk system 20) receives electronic submittal form 102 and associated agenda item documents at step 180. Once all required approvals have been obtained, board manager system 50 reviews the recommendations of the reviewing system and determines if agenda item package 22 will be submitted for consideration to the governing body. If approved by board manager system 50, electronic submittal form 102 and any electronically available associated documents are e-mailed back to board clerk system 20. A hard-copy of agenda item package 22 (i.e., electronic submittal form 102, and all associated hard-copy and electronic agenda item documents) are also provided to board clerk system 20.

At step 190, since electronic submittal form 102 contains fields of information that can be automatically extracted, the information contained therein is used to populate a relational database stored in clerk's repository 90, or a work flow software package running on board clerk system 20, for further processing. Software running on board clerk system 20 having form populating capabilities can be used to extract the information. Most, if not all, of the information that would ultimately appear in an meeting agenda for a meeting is recorded in the fields of electronic submittal form 102.

At step 200, electronic submittal form 102 and associated agenda item documents are distributed to board manager system 50, that reviews electronic submittal form 102 to determine whether any research should be conducted before a proposed agenda item is added to the meeting agenda. Once board manager system 50 determines the amount of research needed and/or identifies the specific areas needing research, electronic submittal form 102 and associated agenda item documents are distributed to researching system(s) 70 to perform the required research. Alternatively, board manager system 50 can utilize the workflow functionality of system 10 to send researching system(s) 50 hyperlinks or URLs pointing to electronic submittal form 102 and associated agenda item documents in an e-mail message. Researching system(s) 70 can access a Web page provided by board clerk system 20 to review the contents of electronic submittal form 102 and associated agenda item documents, and note their comments and research results therein. Researching system 70 accesses storage server 110 for historical archives associated with the proposed agenda item stored in clerk's repository 90 to determine if the particular item has ever appeared in an agenda item package 22 before, what action was taken by the board, etc. Alternatively, these historical archives can be in hard-copy, microfiche or electronic form. Researcher(s) at researching system(s) 70 then note his/her findings on electronic submittal form 102 and the workflow software automatically notifies board manager system 50.

At step 210, after electronic submittal form 102 and associated agenda item documents have gone through the research and recommendation processes, board manager system 20 makes a final recommendation to the governing body at step 210, and the proposed agenda item associated with electronic submittal form 102 and associated agenda item documents will be made available for adding to the governing body's meeting agenda. Board manager system 20 makes the recommendation electronically by entering information on electronic submittal form 102, which records the information in a database stored in clerk's repository 90. For example, a field in submittal form 102 can include an indication that the proposed agenda item is approved for a meeting agenda on a particular date. The agenda coordinator (i.e., board clerk 20) may add additional information such as “Who is doing the invocation?” or “Are there special guests at the meeting?”

A preliminary meeting agenda can be generated at any time if desired by querying the database stored in clerk's repository 90 and running a report from the database. Typically, board clerk system 20 receives the recommendation and generates the meeting agenda electronically at step 220. Board clerk system 20 generates an electronic report that contains organized information on all agenda items contained in an meeting agenda that have been given a final recommendation. This report can be exported to a .pdf, .ppt, .html, .xml or .rtf file, for example, and/or a popular word processing software. An updated meeting agenda is generated such that each agenda item has a hyperlink or URL pointing to electronic submittal form 102 and associated agenda item documents that were created and received, respectively, at the beginning of the process (step 130). Specifically, board clerk system 20 generates agenda auto-filled template 104 electronically using the information stored in clerk's repository 90 that contains organized information on all agenda item packages 22 that have been given the final recommendations and approvals. In this particular embodiment, auto-filled template 104 is generated such that each agenda item contains a hyperlink or URL pointing to electronic submittal form 102, each submittal form 102 in turn containing hyperlinks or URLs pointing to each of the associated documentation that was created in the beginning of the process (step 130). After auto-filled template 104 containing the approved agenda items is produced electronically, it is stored in storage server 110 for subsequent searching and retrieval.

At step 230, after the meeting agenda is generated electronically, it is distributed to members of the governing body for voting and/or implementation via email 112, production printer 114 for printing and mailing, fax 116 for network or regular faxing, CD-ROM mailing 118 and hard-copy delivery. However, in this particular embodiment, an Intranet or the Internet is utilized by way of web 120. The meeting agenda is published on an Intranet and/or the Internet at step 240. Individuals, including agenda participant systems and/or the general public, can view the published agenda by accessing a Web page provided by board clerk system 20. Additionally, the meeting agenda can be distributed to members of a distribution list using any of the distribution methods described above.

At step 250, members of the governing body (i.e., board meeting system 52) vote and their actions are stored in the manner described above for entering information associated with a particular agenda item or associated document in electronic submittal form 102. However, it should be noted that the voting and actions information can be taken manually during an meeting governing body meeting. The voting and actions are then stored in electronic submittal form 102 in the manner described above for storing other related information. Electronic submittal form 102 now contains a complete record of the history of the agenda items for an meeting agenda.

At step 260, board clerk system 20 generates meeting minutes resulting from the voting, actions and other discussions during a board meeting, and populates auto-filled template 104 using the form populating software mentioned above. It should be noted that board clerk 20 can communicate with a third party voting system software application for storing voting information. As described above with respect to using auto-filled template 104 to add approved agenda items to an meeting agenda using information obtained from clerk's repository 90, the meeting minutes are stored in storage server 110 for subsequent searching and retrieval. The meeting minutes can be quickly reproduced and distributed using any of the distribution methods described above. Within a specified amount of time after board meeting system 52 has voted, such as 24 hours, the minutes are published as described above as well. Further, the meeting minutes contain all of the information that was included on the meeting agenda along with the actions and votes, except for the associated agenda item documents since the minutes are published on an Intranet and/or the Internet containing hyperlinks or URLs pointing to the meeting agenda, which contain the hyperlinks or URLs for each electronic submittal form 102 and associated agenda item documents for each item in the agenda as described above, thereby completing the process. An added benefit of publishing the meeting minutes on web 120 is that the original agenda item package 22, including electronic submittal form 102 and all associated agenda item documents, are accessible via hyperlinks or URLs from the meeting minutes. Additionally, it should be noted that board clerk system 20 can generate other administrative reports, including long-range agendas showing meeting agendas for future dates.

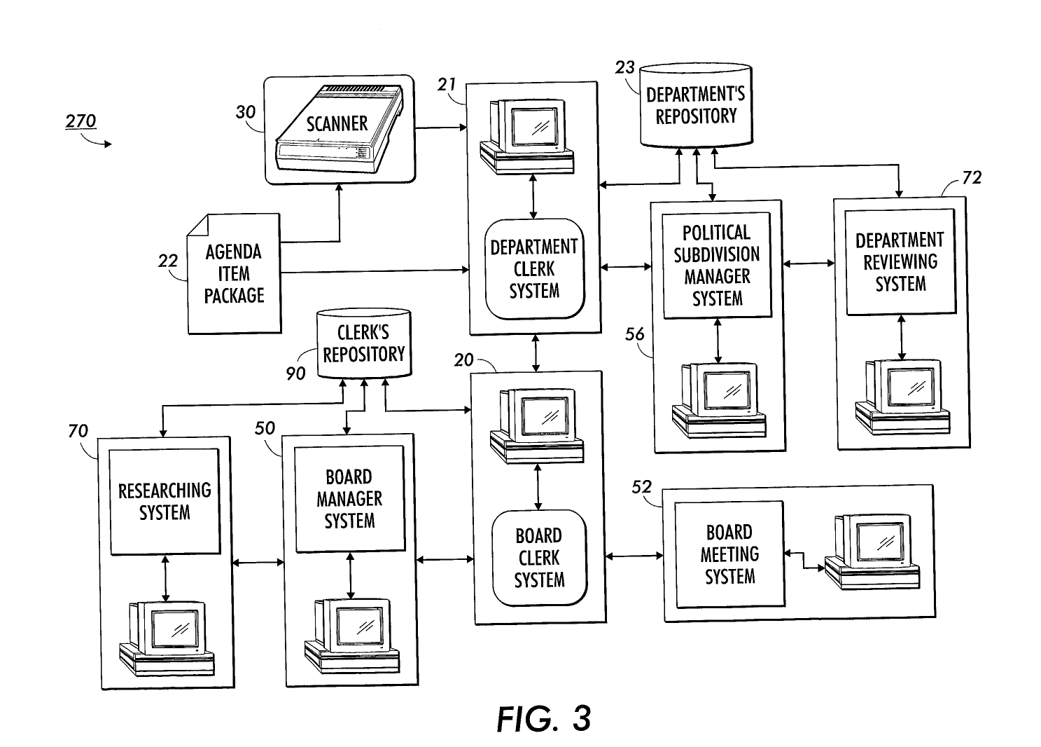

Referring more specifically to FIG. 3, system 270 for agenda management where the scanning and document management are decentralized will now be described, in accordance with another embodiment of the present invention. Identical structures or systems to those described earlier will be referred to with the same reference numbers herein. Thus, the following embodiment will be discussed to the extent it differs from the above-described embodiment (FIG. 1), or as necessary for coherency.

This particular embodiment is the same as the above-described embodiment described in connection with FIG. 1, except that scanner 30 and reviewing system 72 may be coupled to department clerk system 21, instead of board clerk system 20. Further, department clerk system 21 may be coupled to a department's repository 23, political subdivision manager system 56 and department reviewing system 72. Department clerk system 21 is coupled to board clerk system 20 and is responsible for coordinating the document processing as discussed in more detail further below herein. As with the agenda participant systems described in greater detail earlier, department clerk system 21, political subdivision manager system 56, and department reviewing system 72 each may comprise a variety of different types of computer processing systems or machines, including personal desktop computers, laptop computers, work stations, palm top computers, Internet-ready cellular/digital mobile telephones, dumb terminals or any other larger or smaller computer systems or servers. Additionally, department clerk system 21, political subdivision manager system 56 and department reviewing system 72 are each programmed with their respective portions of the instructions for managing an agenda in accordance with the present invention to be executed by the processor or processors in systems 21, 56, and 72. In this particular embodiment, department clerk system 21 is operated by a departmental clerk and/or a governing body's subdivision manager, although other individuals could operate this system.

The basic operation of system 270 where the scanning and document management are decentralized will now be described, in accordance with another embodiment of the present invention. Identical steps to those described earlier will be referred to herein with the same reference numbers given in FIG. 2. Thus, the following embodiment will be discussed to the extent it differs from the operation of the above-described embodiment (FIG. 2), or as necessary for coherency.

In this particular embodiment, steps 130-170 are performed by department clerk system 21, political subdivision manager system 56 and department reviewing system 72 instead of board clerk system 20, board manager system 50 and reviewing system 54, respectively, and agenda item package 22, including submittal form 102 and the associated agenda item documents, is stored in department's repository 23 instead of clerk's repository 90. After step 170 is performed as described above, once political subdivision manager system 56 approves adding the proposed agenda item to the meeting agenda, department clerk system 21 retrieves agenda item package 22 from department's repository 23 and distributes it to board clerk system 20, where it is then stored in clerk's repository 90 for completion of steps 180-260. Alternatively, department clerk system 21 distributes a hyperlink or URL pointing to agenda item package 22 so board clerk system 20 can access department's repository 23 and store agenda item package 22 as described above. Thereafter, steps 180-260 are performed as described above in connection with FIG. 2.

This particular embodiment of the present invention enables the governing body to automate the entire agenda review and approval process by extending the document management and scanning functionality out to department clerk system 21 for creating the agenda items to be added to the meeting agenda. Also enables the integration of departmental agenda systems with enterprise-wide agenda processing systems.

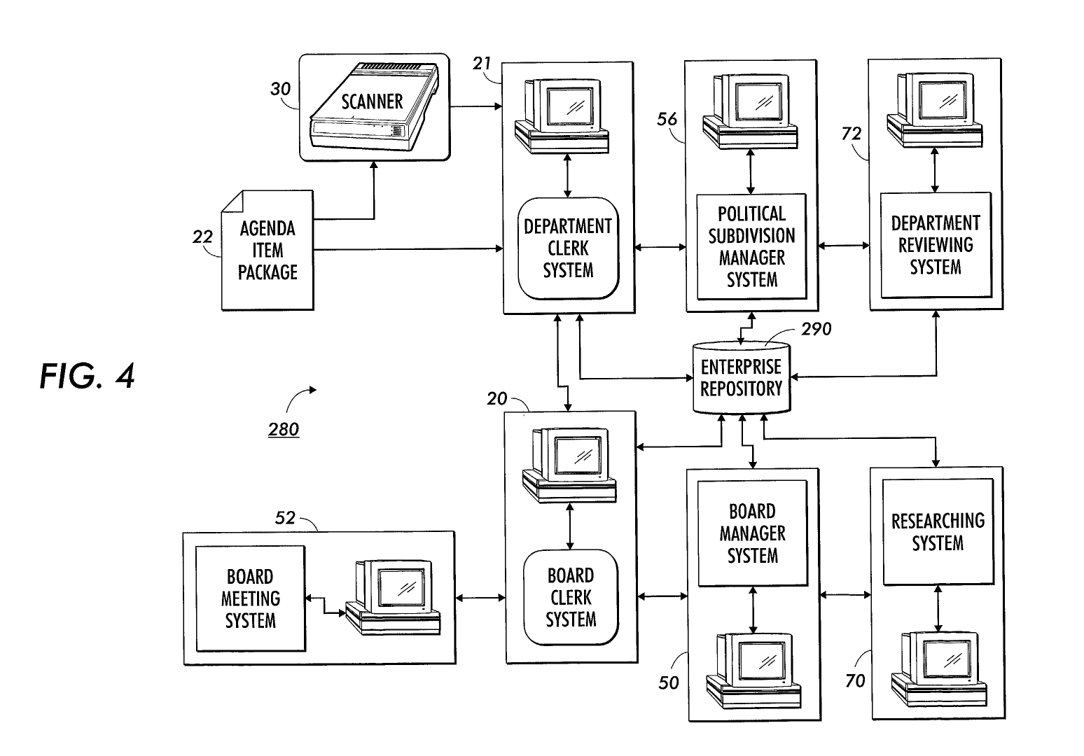

Referring specifically to FIG. 4, system 280 for agenda management where the scanning is decentralized and the document management is centralized will now be described, in accordance with another embodiment of the present invention. Identical structures to those described earlier will be referred to with the same reference numbers herein. Thus, the following embodiment will be discussed to the extent it differs from the above-described embodiments (FIGS. 1 and 3), or as necessary for coherency.

This particular embodiment is the same as the above-described embodiment described in connection with FIGS. 1 and 3, except that department clerk system 21 is coupled to enterprise repository 290 instead of department's repository 23. Further, board clerk system 20 is coupled to enterprise repository 290 instead of clerk's repository 90.

The basic operation of system 280 where the scanning is decentralized and the document management is centralized will now be described, in accordance with another embodiment of the present invention. Identical steps will be referred to herein with the same reference numbers given in FIG. 2. Thus, the following embodiment will be discussed to the extent it differs from the operation of the above-described embodiment, or as necessary for coherency.

In this particular embodiment, steps 130-170 are performed by department clerk 21, political subdivision manager 56 and department reviewing system 72, instead of board clerk system 20, board manager system 50 and reviewing system 54, respectively, and agenda item package 22, including submittal form 102 and the associated agenda item documents, is stored in enterprise repository 290 instead of department's repository 23. After step 170 is performed as described above, once political subdivision manager system 56 approves adding the proposed agenda item to the meeting agenda, department clerk system 21 retrieves agenda item package 22 from enterprise repository 290 and distributes it to board clerk system 20 for completion of steps 180-260. Alternatively, department clerk system 21 distributes a hyperlink or URL pointing to agenda item package 22 so board clerk system 20 can access enterprise repository 290 and perform steps 180-260 as described above.

Thus, in this particular embodiment, the ability to search multiple repositories may be required, but simplified from the prior embodiments since they are homogeneous.

The above described agenda management system in accordance with at least one embodiment of the present invention processes paper documents that are received from within or outside a governing body, tracks the progress of agenda items as they undergo the review/approval process, automatically creates an agenda and meeting minutes, reduces copying and printing requirements, and can publish and distribute last minute agenda items. This provides easier public access to meeting agendas and meeting minutes, making archived documents available to all governing body departments for research purposes, and ensures the accuracy and completeness of the agenda items and attachments.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. A method for managing an agenda, the method comprising:
determining if one or more agenda items are approved for inclusion in a meeting agenda electronically;
adding the approved agenda items to the meeting agenda to generate an updated agenda electronically; and
publishing the updated agenda.

2. The method as set forth in claim 1 further comprising:
providing an electronic submittal form associated with one or of the agenda items;
providing one or more electronic documents for each of the agenda items; and
generating each of the agenda items from one of the electronic submittal form and the associated one or more of the electronic documents.

3. The method as set forth in claim 2 further comprising:
storing each of the electronic documents in a memory; and
providing an electronic link for each of the stored electronic documents in each of the agenda items, wherein the electronic link is used to retrieve the electronic document from the memory.

4. The method as set forth in claim 1 wherein the determining further comprises:
requesting one or more recommendations on the approval of each of the agenda items for inclusion in the meeting agenda electronically;
providing a response to each of the requests for recommendation;
requesting the approval of each of the agenda items for inclusion in the meeting agenda electronically; and
providing a response to the request for the approval of each of the agenda items for inclusion in the meeting agenda.

5. The method as set forth in claim 4 further comprising:
tracking a status of each of the requests for the recommendation; and
providing the status of each of the requests for the recommendation electronically upon request.

6. The method as set forth in claim 1 further comprising:
receiving voting information on each of the agenda items electronically;
storing the voting information on each of the agenda items with the updated agenda electronically;
providing the voting information on each of the agenda items when requested.

7. The method as set forth in claim 1 further comprising:
recording minutes of a meeting on one or more of the agenda items in the updated agenda electronically;
storing the recorded minutes associated with the updated agenda; and
providing the recorded minutes when requested.

8. The method as set forth in claim 1 wherein the publishing the updated agenda further comprises distributing the updated agenda electronically to a distribution list.

9. A computer readable medium having stored thereon instructions for managing an agenda which when executed by one or more processors, causes the processors to perform:
determining if one or more agenda items are approved for inclusion in a meeting agenda electronically;
adding the approved agenda items to the meeting agenda to generate an updated agenda electronically; and
publishing the updated agenda.

10. The medium as set forth in claim 9 further comprising:
providing an electronic submittal form associated with one or of the agenda items;
providing one or more electronic documents for each of the agenda items; and
generating each of the agenda items from one of the electronic submittal form and the associated one or more of the electronic documents.

11. The medium as set forth in claim 10 further comprising:
storing each of the electronic documents in a memory; and
providing an electronic link for each of the stored electronic documents in each of the agenda items, wherein the electronic link is used to retrieve the electronic document from the memory.

12. The medium as set forth in claim 9 wherein the determining further comprises:
requesting one or more recommendations on the approval of each of the agenda items for inclusion in the meeting agenda electronically;
providing a response to each of the requests for recommendation;
requesting the approval of each of the agenda items for inclusion in the meeting agenda electronically; and
providing a response to the request for the approval of each of the agenda items for inclusion in the meeting agenda.

13. The medium as set forth in claim 12 further comprising:
tracking a status of each of the requests for the recommendation; and
providing the status of each of the requests for the recommendation electronically upon request.

14. The medium as set forth in claim 9 further comprising:
receiving voting information on each of the agenda items electronically;
storing the voting information on each of the agenda items with the updated agenda electronically; and
providing the voting information on each of the agenda items when requested.

15. The medium as set forth in claim 9 further comprising:
recording minutes of a meeting on one or more of the agenda items in the updated agenda electronically;
storing the recorded minutes associated with the updated agenda; and
providing the recorded minutes when requested.

16. The medium as set forth in claim 9 wherein the publishing the updated agenda further comprises distributing the updated agenda electronically to a distribution list.

17. A system for managing an agenda, the system comprising:
a determination processing system that determines if one or more agenda items are approved for inclusion in a meeting agenda electronically;
an agenda processing system that adds the approved agenda items to the meeting agenda to generate an updated agenda electronically; and
a publishing system that publishes the updated agenda.

18. The system as set forth in claim 17 further comprising:
submittal form processing source that provides an electronic submittal form associated with one or more of the agenda items;
a document processing source that provides one or more electronic documents for each of the agenda items; and
an agenda item processing system that generates each of the agenda items from one of the electronic submittal form and the associated one or more of the electronic documents.

19. The system as set forth in claim 18 further comprising:
a memory for storing each of the electronic documents; and
a link processing system that provides an electronic link for each of the stored electronic documents in each of the agenda items, wherein the electronic link is used to retrieve the electronic document from the memory.

20. The system as set forth in claim 17 wherein the determining further comprises:
a request processing system that requests one or more recommendations on the approval of each of the agenda items for inclusion in the meeting agenda electronically and that requests the approval of each of the agenda items for inclusion in the meeting agenda electronically;
a recommendation processing system that provides a response to each of the requests for recommendation; and
an approval processing system that provides a response to the request for the approval of each of the agenda items for inclusion in the meeting agenda.

21. The system as set forth in claim 20 further comprising:
a tracking processing system that tracks a status of each of the requests for the recommendation; and
a memory for storing the status of each of the requests for the recommendation.

22. The system as set forth in claim 17 further comprising:
a vote processing system that receives voting information on each of the agenda items electronically;
a memory for storing the voting information on each of the agenda items with the updated agenda.

23. The system as set forth in claim 17 further comprising:
a record processing system that records minutes of a meeting on one or more of the agenda items in the updated agenda electronically; and
a memory for storing the recorded minutes associated with the updated agenda.

24. The system as set forth in claim 17 wherein the publishing system further comprises a distribution processing system that distributes the updated agenda electronically to a distribution list.
